(19) United States
(12) Patent Application Publication
(10) Pub. No.: US 2009/0094584 A1
(43) Pub. Date: Apr. 9, 2009

(54) NON-INTRUSIVE ASSET MONITORING FRAMEWORK FOR RUNTIME CONFIGURATION OF DEPLOYABLE SOFTWARE ASSETS

(75) Inventors: VIJAY DHEAP, DURHAM, NC (US); BENJAMIN M. SCHELL, MORRISVILLE, NC (US); JASON WAGNER, STATE COLLEGE, PA (US); MICHAEL D. WHITLEY, WEDDINGTON, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/867,473

(22) Filed: Oct. 4, 2007

(51) Int. Cl. G06F 9/44

(52) U.S. Cl. 717/130

(57) ABSTRACT

The present invention discloses a solution for metering, monitoring, and monetizing software assets. The solution can include a step of registering a software asset with a monitoring service. A unique identifying key for the software asset can be generated during registration. The software asset can then be instrumented for the monitoring service. The instrumentation can reference the software asset by the unique key. Specifics of the set of metrics that are to be monitored by the monitoring service for the software asset can be runtime, development time, and/or deployment time configurable. The instrumented software asset can convey transaction data to the monitoring server when used by clients. Analyzed results produced by the monitoring service pertaining to the software assets based upon the transaction data can be provided to authorize users of vendors associated with the software asset.

### BACKGROUND

1. Field of the Invention

The present invention relates to an asset monitoring framework, and more particularly, to a runtime configurable solution for tracking content and services that supports a variety of asset types, such as content, widgets, mashups, service oriented architecture (SOA) applications, and Web 2.0 environments.

2. Description of the Related Art

The Web is increasingly becoming an interactive data exchange forum, where users submit content to Web servers, which is shared with other users, sometimes after processing. This evolution of the World Wide Web has been called Web 2.0, which refers to a read, write, updatable Web. Traditionally, Web server owners have competed for consumer attention by providing customer desired offerings, for which they are financially rewarded through advertising revenue, goodwill, lower customer service costs, resale of metrics of usage patterns, usage fees, and the like.

Web services add a further complication to this already dynamic environment. Web services are independent software modules adhering to known standards, such as those published by the World Wide Web consortium (W3C). Web services are often created by third party developers, which are integrated into Web based offerings of other vendors that enhance a functionality of these offerings. In addition to Web services, other software assets have emerged that represent enhancements to offerings of other vendors. These assets include, for example, Web content, widgets, mashups, service oriented architecture (SOA) applications, and the like.

In many situations, a single solution utilized by a user is formed from many assets by multiple different providers. The solution itself can represent a remixing of content and services by the providers themselves or by middlemen into solutions that are consumed by users as a single view. Additionally, services and content can vary in granularity. Some can be fine grained, while others can be delivered in bulk. For example, business information can be tailored for delivery to a single company compared to delivering business information to a set of one thousand companies (e.g., Dun and Bradstreet business information).

Increasingly, an issue of compensation for providing assets is arising. Compensation is linked to an associated challenge of asset usage tracking. Asset providers are increasingly demanding ways to track usage, to recognize content flows, and to monetize transactions. The different levels of granularity and the different composite views present in many consumable solutions add substantial complications to asset tracking. Two predominant techniques in existence today are to either self-host an asset monitoring capability or to use a hosted asset monitoring solution.

Self-hosted software solutions use proprietary interfaces and require low-level integration into a vendor's software assets. Self-hosted solutions can be costly since vendors must purchase a monitoring software package, must modify existing software assets in a software development phase, and then maintain the server and the monitoring software. After integrating a monitoring solution at a low-level, vendors are effectively locked into a proprietary solution, since changing to a different solution is time consuming and costly.

Using hosted asset monitoring solutions incurs a lower upfront cost than hosted solutions, since integration with a Web based software asset is generally simplistic. For example, a JAVA Script linked to a hosted monitoring solution may need to be added to each Web page that is to be monitored. One problem with this type of solution is that it is generally limited to a front-end interface. As such, it can be difficult if not impossible to monitor software assets at various granularity levels and not just an interface level. Another significant problem with hosted solutions is surrendering ownership of customer relationships to a third party providing the monitoring solution. That is, monitoring solutions (e.g., GOOGLE Analytics) monitor vendor/customer relationships and use this information to their advantage. For example, once a customer is known to interact with a vendor, competing vendors can be placed in contact with the customer for an advertising based fee.

### SUMMARY OF THE INVENTION

The present invention can be implemented in accordance with numerous aspects consistent with the material presented herein. For example, one aspect of the present invention can include a method for metering, monitoring, and monetizing software assets. The method can include a step of registering a software asset with a monitoring service, at which point metrics that are to be tracked are provided by an asset vendor. A unique key for the software asset can be received as a result of the registration. It should be appreciated that specific type of software assets, such as widgets, can permit registration at either runtime or at deployment time. In one embodiment, the unique key can be an automatically generated one. The software asset can then be instrumented for the monitoring service. The instrumentation can reference the software asset by the unique key. Specifics of the set of metrics that are to be monitored by the monitoring service for the software asset can be runtime, development time, or deployment time configurable. The instrumented software asset can convey transaction data to the monitoring server when used by clients. Analyzed results produced by the monitoring service pertaining to the software assets based upon the transaction data can be provided to authorize users of vendors associated with the software asset. In one embodiment, vendors can register authorized consumers for the content or service such that the asset can determine if a specific user is authorized for consuming or using the asset. Registering consumers for software assets can be a significant factor for monetizing the assets as consumer specific limits, and monitors can be established on a per-asset basis.

Another aspect of the present invention can include another method for metering, monitoring, and monetizing software assets. In the method, at least one software asset can be served to a plurality of clients, wherein said software asset comprises instrumentation for a monitoring service. Each client can use the software asset within a client-side interface. Each client can also convey transaction data associated with a use of the software asset to the monitoring service in accordance with specifics of the instrumentation. The monitoring service can be a software service executing within a monitoring server. Analyzed results produced by the monitoring service pertaining to the software assets based upon the transaction data can be provided to authorized users associated with the software assets, such as a set of users who have been registered by an asset vendor. A set of metrics that are to be monitored by the monitoring service for the software asset can be runtime, development time, or deployment time configurable by the vendor associated with the software asset.

Still another aspect of the present invention can include a monitoring system for software assets that includes a monitoring service. The monitoring service can be configured to track usage, recognize content flows, and to monetize transactions for a set of software assets. Each software asset can be registerable with the monitoring service, which permits metrics for the monitoring service to be configured to monitor different metrics on an asset-by-asset basis. Metric specifics for each of the monitored assets can be runtime, development time, and/or deployment time configurable by vendors associated with each of the runtime assets. When metrics for an asset are configurable can depend upon a type of software asset and a manner in which the asset has been instrumented.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system showing an asset monitoring framework for runtime, deployment time, and/or development time configuration of deployable software assets.

FIG. 2 is a schematic diagram of a system for an asset monitoring framework that permits runtime, deployment time, and/or development time instrumentation of deployable software assets in accordance with an embodiment of the inventive arrangements disclosed herein.

### DETAILED DESCRIPTION OF THE INVENTION

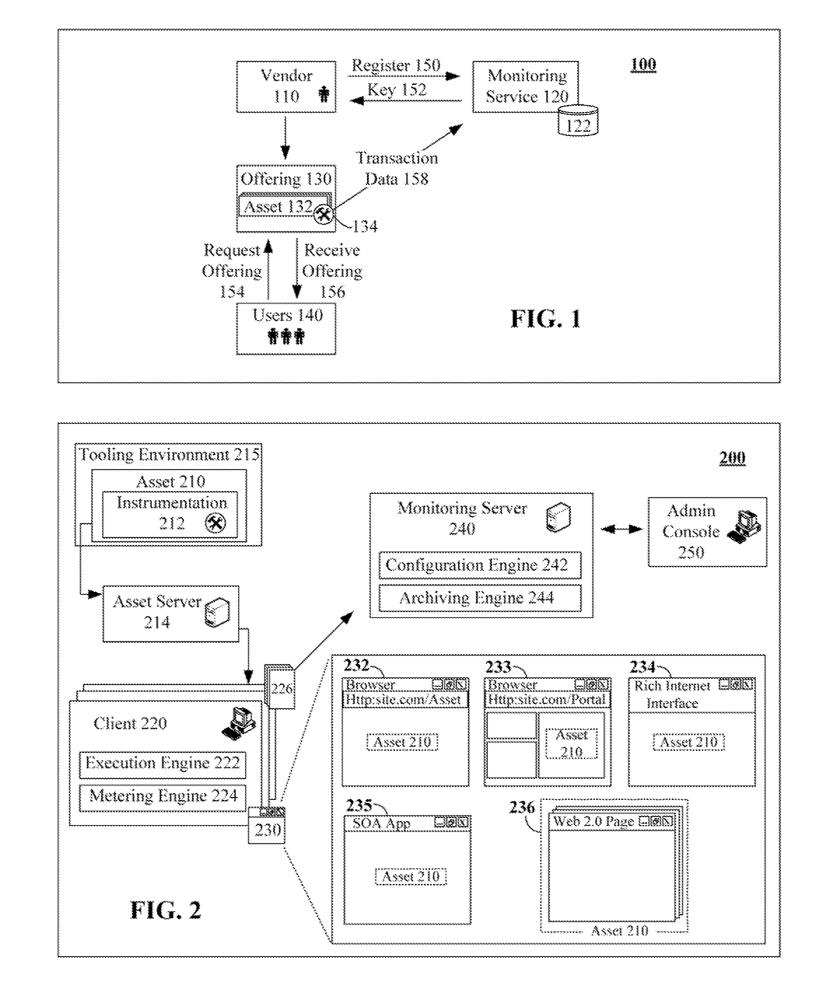

FIG. 1 is a schematic diagram of a system 100 showing an asset monitoring framework for runtime, deployment time, and/or development time configuration of deployable software assets. In system 100, a vendor 110 can register 150 an offering 130 with a metering, monitoring, and monetizing service 120. The service 120 can provide the vendor 110 with a unique key associated with the registered offering, which can be an automatically generated key or a manually established one. Then the vendor 110 can instrument 134 the offering 130 using the unique key. The offering 130 can include one or more software assets 132 and instrumentation can occur at an asset 132 level. Users 140 can then request 154 and receive 156 the offering 130. Transaction data 158 can be recorded for interactions between the offering 130 and the users 140. This transaction data 158 can be conveyed to the service 120, where it can be processed by service 120. Processing results and raw data can be stored in data store 122. The vendor 110 can request and receive reports and other information concerning the offering 130 through the service 120. Security for the stored and processed transaction data 158 can be maintained so that it is available only to authorized agents appointed by the vendor 110.

System 100 has numerous advantages over conventional asset monitoring solutions. One advantage is that in system 100 a relationship between vendors 110 and users 140 is kept confidential, which ensures that the vendor 110 continues to “own” the relationship. System 100 also permits vendors 110 to configure desired metrics at runtime, deployment time, or deployment time, such as through a configurable Consumer Data Record (CDR) that can be part of the instrumentation 134. Additionally, system 100 supports instrumentation 134 of content and services of varying granularity. When a software asset 132 includes multiple subcomponents, which can potentially be associated with different vendors, each of the subcomponents can be instrumented 134 separately, providing different levels of visibility into metrics depending on an instrumentation 134 level that a vendor is authorized to access. In one contemplated embodiment, the users 140 can be permitted to access the service 120, either directly or through a vendor supplied interface, to view their consumption habits.

Another significant advantage of system 100 is that it permits software assets 132 to be monetized. For example, a vendor 110 can register authorized users 140 for a software asset 132. Value formulas can be defined within the instrumentation 134 to calculate cost incurred using an asset 132 and/or to determine revenue potential of an asset 132. Limits can be applied to usage of the asset 132 based upon usage amounts that users 140 have paid or are contracted to pay for asset 132 utilization. For example, a limited usage below an established threshold of the asset 132 can be permitted for no cost, but users 140 can be required to pay for asset usages over the threshold. Functionality limits can also be imposed upon the asset 132 so that fees are required to unlock (remote a limit from) an otherwise unavailable asset 132. In one embodiment, different registered users 140 can be grouped into different offering categories, which define a manner in which a user 140 is able to utilize an asset 132.

The service 120 can be implemented in either a self-hosted system or within a third-party system, which permits vendor 110 to retain a consistent infrastructure for monitoring assets 132 regardless of an implementation framework used. Offloading overhead relating to monitoring the offering 130 by using third-party hosting can permit the vendor 110 to concentrate on core competencies. Self-hosting a monitoring capability can permit the vendor 110 to use software monitoring tools of choice and can permit the vendor 110 to operate autonomous from third party systems. Templates can be established for one or more Commercial-Off-the-Shelf (COTS) monitoring solutions so that instrumentation 134 of the offering 130 can remain consistent regardless of what monitoring solution is used. Consistent instrumentation 134 also permits a vendor 110 to switch monitoring solutions and/or to change whether monitoring service 120 is self hosted or hosted by a third-party without requiring extensive implementation specific customizations. Templates can also be used to OEM the metering, monitoring, and monetizing service into products and solutions.

As used herein, the vendor 110 can be an owner or provider of a software offering 130. A software offering 130 can include one or more software assets 132. Software assets 132 can include a variety of software services and content. The service 120 can be a software implemented service configured to track usage, content flows, monetize transactions, registration of consumers, managing multiple offerings 130 (e.g., group offer capabilities), establish limits and specification of value formulas, and the like. The monitoring service 120 permits a capturing and reporting of metrics relating to transactions (158) for each asset 132 along a content or service delivery cycle and to correlate these metrics for vendor 110 consumption.

The instrumentation 134 can decouple service 120 specifics from asset 132 specifics, which results in an extremely flexible and versatile infrastructure. For example, usage calculation algorithms, usage limitations, metric recordation specifics, and the like can be specified within the instrumentation 134. This information can be altered by a vendor 110 at development time, at runtime, and/or at deployment time. In one embodiment, the instrumentation 134 can include analyzing capabilities that can be used to calculate various value formulas using usage data and to derive knowledge of usage behavior and content flows. The architecture of system 100 also supports data portability, such as allowing additional analysis algorithms to be applied to the asset 132 via the instrumentation 134 either as plug-ins or by exporting the data.

FIG. 2 is a schematic diagram of a system 200 for an asset monitoring framework that permits runtime, deployment time, and/or development time instrumentation of deployable software assets in accordance with an embodiment of the inventive arrangements disclosed herein. The system 200 is one contemplated implementation for the system 100 of FIG. 1.

System 200 shows that an asset 210 can be instrumented 212 and conveyed to an asset server 214, which one or more clients 220 access via an interface 230. When the asset 210 is accessed, transaction data 226 concerning the transaction can be conveyed to a monitoring server 240, which processes and archives the transaction data 226. An authorized vendor of the asset 210 can access the monitoring server 240 via an administration console 250 to receive reports/data concerning the monitored metrics. In one embodiment, the information provided to a vendor via the administration console 250 can include real-time or near real-time metrics.

To elaborate, in system 200, one or more assets 210 can be instrumented within a tooling environment 215. Instrumentation 212 can permit the asset 210 to transmit transaction data 158 when used by clients 220. In one embodiment, a standard asset monitoring application program interface (API) can be established. The instrumentation 212 can cause API calls to be made to track the metrics that are pertinent to the content or services that are to be tracked. A configurable metric specification section (e.g., Customer Data Record) of the instrumentation 212 can be used to define metrics that are to be tracked on an asset-by-asset basis. That is, different metrics can be tracked for different assets 210. In one embodiment, each asset 210 can be registered with a monitoring service, which creates a unique asset specific key. This key can be included in the instrumentation 212 and can be conveyed along with transaction data 226 to the monitoring server 240.

Configuring the instrumentation 212 can occur in a pre or post asset 210 deployment stage. In a post asset 210 deployment stage, the asset owner need not have direct access to an asset executing entity (e.g., server 214 and/or client 220), and need not even be aware of where deployed assets are located. For example, a fact that communications are established between the monitoring server 240 and deployed assets 210 can be leveraged to make adjustments to deployed assets 210. That is, an authorized administrator using console 250 can make a run-time change for a set of assets 210 that are already being monitored by the server 240. These changes can be conveyed from the server 240 to the asset executing entity (server 214 and/or client 220), where changes to the instrumentation 212 (e.g., the Customer Data Record) can be dynamically made, which changes the content of subsequent transaction data 226 messages.

The tooling environment 215 can optionally include a toolkit for a software development platform, which automatically creates assets 210 that include stubs or interfaces for instrumentation 212. For example, if a software development platform was part of an IBM RATIONAL software development platform, a platform specific metering toolkit can facilitate the instrumentation 212 of assets 210. Specifications can be published for instrumentation 212 requirements so that metering toolkits for any software development platform can developed. In another example, a class or script can be designed to facilitate instrumentation 212 of assets 210, where in the tooling environment 215 the facilitating class or script can be added to asset 210 code. The tooling environment 215 can also software wrap pre-existing assets 210 where the software wrapping includes the instrumentation 212 for monitoring the assets 210. Implementation specifics for the tooling environment 215 can vary based upon asset type 210 and/or based upon a platform for which the asset 210 is designed.

An asset 210 can represent any software object or set of objects able to be monitored using instrumentation 212. For example, asset 210 can include digitally encoded content, such as data, an electronic file, multimedia, a stream, a syndication, a Web page, a portal, a portlet, and the like. The asset 210 can also include a widget, a mashup, a service oriented architecture (SOA) application, a Web 2.0 environment, a Rich Internet Interface (RII) application, and the like. An asset 210 can be a component of another offering by a different vendor, which may or may not be monitored. Further, different assets 210 can monitor for different metrics, each being separately configurable.

Code associated with the assets 210 can execute on the asset server 214 and/or on the client 220. An execution engine 222 can execute a client-side portion of code for the assets 210 and/or an application needed to interact with the asset 214. For example, an asset 214 can be a Web page 232 having dynamic content processed by the server 214 presented within a Web browsing interface 232, code for which is executed by the execution engine 222. The asset 210 can be a portion of a served Web solution, such as a portlet, as shown by interface 233. Similarly, the asset 210 can represent a set of Web components, such as a Web 2.0 environment, as shown by interface 236. In one embodiment, an asset 210 can execute in a Rich Internet Interface (RII) 234, which case interface code for the RII can be executed by the engine 222. Additionally, the asset 210 can be a service oriented architecture asset 210 executing in an interface 235.

Regardless of a type 232-236 of interface 230 used to interact with the asset 210, metering the asset 210 can occur in a consistent fashion. In one implementation, the instrumentation 212 can include an executable designed to run on client 220 (e.g., specifically a client-side metering engine 224 can handle the executable), which generates transaction data 226. In another implementation, the instrumentation 212 can include configuration specific data for the asset 210, which is designed to be interpreted by a separate client-side executable (e.g., metering engine 224). Further, in one implementation a standard client-side program can execute on the client 220, such as a metering engine 224 that is implemented within a JAVA virtual machine. In still another implementation, an asset server 214 can perform at least a portion of the processing tasks needed to generate the transaction data 226.

The monitoring server 240 can receive the transaction data 226, which it can process in accordance with vendor configurable parameters. These parameters can be established using the configuration engine 242. Processing specifics can be established by a vendor at a time at which assets 210 are registered with the monitoring server 240 and/or at a later point in time. The monitoring server 240 can also include an archiving engine 244, which is used to store processed results of transactions and raw transaction data. The monitoring server 240 can be capable of tracking usage, content flows, monetizing transactions, managing multiple offerings (e.g., asset grouping capabilities), establishing limits and specification of value formulas, and the like. Functionality of the monitoring server 240 can utilize any of a variety of programmatic techniques for monitoring the assets. For example, techniques currently incorporated by existing software solutions, such as IBM's Web Analytics, WEB TRENDS solutions, URCHIN Web Analytics Software, CLICKTRACKS, AWStats, OMNITURE analytics software, etc., can be used by server 240. Additionally, templates can be designed for any of the afore mentioned COTS analyzing solutions to make those solutions compatible with the instrumentation 212.

It should be noted that the infrastructure of system 200 allows metrics to be captured and recorded at multiple points of the software asset's solution delivery cycle. For example, front-end, back-end, and in-between metrics can be captured and conveyed to the monitoring server 240 as separate records. These separate records can be resolved and correlated using the unique key associated with the software asset 210.

The client 220 can represent any computing device that permits a user to interact with one or more assets 210 via interface 230. For example, the client 220 can be a personal computer, a server, a mobile telephone, a personal data assistant, an entertainment system, a media player, a wearable computing device, an embedded computing device, a virtual machine, and the like.

The components shown in system 200 (server 214, client 220, server 240, and console 250) can exchange information with each other over a network (not shown). The network can include components capable of conveying digital content encoded within carrier waves. The content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

Additionally, each of the components of system 200 can have access to one or more data stores, within which digitally encoded information is stored. Each of these data stores can be physically implemented within any type of hardware including, but not limited to, a magnetic disk, an optical disk, a semiconductor memory, a digitally encoded plastic memory, a holographic memory, or any other recording medium. A data store can be stand-alone storage unit as well as a storage unit formed from a plurality of physical devices, which may be remotely located from one another. Additionally, information can be stored within a data store in a variety of manners. For example, information can be stored within a database structure or can be stored within one or more files of a file storage system, where each file may or may not be indexed for information searching purposes. The data stores can be optionally encrypted for security reasons.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method for monitoring software assets comprising:
registering a software asset with a monitoring service;
instrumenting the software asset for the monitoring service, wherein the instrumentation references the software asset by the unique key, wherein specifics of the a set of metrics that are to be monitored by the monitoring service for the software asset are runtime configurable, wherein the instrumented software asset conveys transaction data to the monitoring server when used by clients, and wherein analyzed results produced by the monitoring service pertaining to the software assets based upon the transaction data are provided to authorized users of vendors associated with the software asset.

2. The method of claim 1, wherein the set of metrics are initially established when registering the software asset, said method further comprising:
receiving a unique generated key for the software asset as a result of the registration.

3. The method of claim 1, further comprising:
changing the set of metrics for the software asset by making changes to the set of metrics within the monitoring service,
the monitoring service conveying a changed set of requirements to the software asset; and
the software asset integrating the changed set into the instrumentation, wherein thereafter the conveyed transaction data comprises data specified within the changed set.

4. The method of claim 1, wherein the specifics of the set of metrics are deployment time, runtime, and development time configurable.

5. The method of claim 1, wherein said software asset comprises at least one of content, a widget, a mashup, a service oriented architecture (SOA) application, and a Web 2.0 environment, and wherein consumers use of the software assets and information pertaining to a relationship between the consumers and the vendors is hidden to ensure the vendor maintains ownership of the relationship.

6. The method of claim 1, wherein the monitoring service comprises an application program interface (API), wherein the vendor is able to instrument a software asset with a call to the API that specifies the set of metrics.

7. The method of claim 1, further comprising:
registering at least one consumer of the software asset with the monitoring service; and
monetizing usage of the software asset for the registered at least one consumer using the monitoring service.

8. The method of claim 1, further comprising:
capturing metrics at a plurality of points of a delivery cycle of the software asset;
conveying messages including the captured metrics to the service along with the unique key identifying the software asset; and
the monitoring service correlating the messages using the unique key.

9. The method of claim 1, wherein said steps of claim 1 are performed by at least one machine in accordance with at least one computer program stored in a computer readable media, said computer programming having a plurality of code sections that are executable by the at least one machine.

10. A method for monitoring software assets comprising:
serving at least one software asset to a plurality of clients, wherein said software asset comprises instrumentation for a monitoring service;
each client using the software asset within a client-side interface; and
each client conveying transaction data associated with a use of the software asset to the monitoring service in accordance with specifics of the instrumentation, wherein the monitoring service is a software service executing within a monitoring server, wherein analyzed results produced by the monitoring service pertaining to the software assets based upon the transaction data are provided to authorized users of vendors associated with the software asset, and wherein a set of metrics that are to be monitored by the monitoring service for the software asset are configurable by the vendor associated with the software asset.

11. The method of claim 10, wherein said at least one software asset comprises a plurality of software assets, wherein monitored metrics for each of the plurality of assets is separately configurable by an associated vendor.

12. The method of claim 11, wherein at least two of the software assets are simultaneously present within at least one of the client-side interfaces, and wherein the client-side interface comprises at least one of a mashup and a portal, wherein said two software assets are discrete components of the mashup or the portal.

13. The method of claim 10, said at least one software asset comprises at least one of content, a widget, a mashup, a service oriented architecture (SOA) application, and a Web 2.0 environment, and wherein consumers using of the software assets and information pertaining to a relationship between the consumers and the vendors is hidden to ensure the vendor maintains ownership of the relationship.

14. The method of claim 10, wherein the monitoring service comprises an application program interface (API), wherein the vendor is able to instrument a software asset with a call to the API that specifies the set of metrics, and wherein the set of metrics are runtime, development time, and deployment time configurable.

15. The method of claim 10, further comprising:
registering at least one consumer of the software asset with the monitoring service; and
monetizing usage of the software asset for the registered at least one consumer using the monitoring service.

16. The method of claim 10, wherein said steps of claim 10 are performed by at least one machine in accordance with at least one computer program stored in a computer readable media, said computer programming having a plurality of code sections that are executable by the at least one machine.

17. A system for software assets comprising:
a monitoring service configured to track usage, recognize content flows, and to monetize transactions for a plurality of software assets, wherein each software asset is able to be registered with the monitoring service, which permits metrics for the monitoring service to be configured to monitor different metrics on an asset-by-asset basis, wherein metric specifics for each of the monitored assets are configurable by vendors associated with each of the software assets, and wherein the monitoring service is a software service stored in a machine readable medium executable by a computing device.

18. The monitoring framework of claim 17, further comprising:
an application program interface (API) for the monitoring service, wherein the vendor is able to instrument a software asset with a call to the API that specifies the set of metrics to be monitored for the software assets.

19. The method of claim 17, wherein said software assets comprise content, widgets, mashups, service oriented architecture (SOA) applications, and Web 2.0 environments, and wherein metric specifics are configurable by the vendors at runtime, at development time, and at deployment time.

20. The monitoring framework of claim 17, wherein the monitoring framework permits consumers using of the software assets and information pertaining to a relationship between the consumers and the vendors to remain hidden to ensure the vendor maintains ownership of the relationship.
